(19) United States
(12) Patent Application Publication
(10) Pub. No.: US 2015/0049467 A1
(43) Pub. Date: Feb. 19, 2015

(54) Hands-Free Device to Illuminate Work Areas

(71) Applicant: Mark R Thompson, North Caldwell, NJ (US)

(72) Inventor: Mark R Thompson, North Caldwell, NJ (US)

(21) Appl. No.: 13/969,672

(22) Filed: Aug. 19, 2013

(51) Int. Cl. B25B 23/18; F21V 33/00

(52) U.S. Cl. CPC B25B 23/18; F21V 33/0084
USPC 362/120

(57) ABSTRACT

A light-weight, hands-free automatic flashlight designed to precisely illuminate the working target area when a screwdriver or other similar tool is being used, not requiring the support or handling from an additional hand as it is inserted into the actual tool being used, and provides this help not obstructing the line of sight.

### FIELD OF THE INVENTION

The present invention relates to a hands-free automatic flashlight designed to illuminate the working target area when a screwdriver is being used, not requiring additional support or handling because it becomes self-ported as it is inserted into the shaft of the mentioned tool.

### BACKGROUND OF THE INVENTION

For as long as humans have tried to screw (or unscrew) fasteners is difficult to reach and more specifically obscure locations, they have always faced a common problem: “not enough light to see what they tried to accomplish”. It is often necessary to use a screwdriver inside of electrical control cabinets, furniture, basement, crawl spaces or attics, or some space restricted locations where there is not sufficient light to see. Another element often makes the task even more challenging: not been able to hold and point a light source (such as a flashlight) to the working area because the other hand must be used for other critical task or simply because it is not enough physical space to put the hand in place, or because that second hand will obstruct the limited field of vision, thus making the job very difficult.

U.S. Pat. Nos. 5,038,481, 5,348,359, and 5,525,842 disclose lighting devices that can be used to illuminate a saber saw, a retriever tool, and an air tool, working areas respectively, but they all are not readily mountable to an screwdriver and so they cannot deliver light right where it is most needed.

Navid, Amir A.; et al, U.S. Pat No. 20020105797 discloses the use of lighting devices for illuminating the work area for a tool.

Padden; Stephen J., U.S. Pat No. 20080212313 discloses a flashlight as tool handle, where its body features a connector to which a tool can be attach.

Wright; Clifford, U.S. Pat No. 20120257378 discloses as illuminated wrench system Flashlight as tool handle, where its body features a connector to which a tool can be attach.

U.S. Pat. Nos. 5,038,481, 5,348,359, and 5,525,842 disclose lighting devices that can be used to illuminate a saber saw.

It is clear that none of the existing art addresses the most important problem, therefore, it is obvious that a need exists for a simple light source that can be readily mountable to a variety of different size of screwdrivers that will illuminate its working area, not requiring the use of a second hand, nor obstructing the view path, and it is able to provide the necessary illumination even in extremely tight working conditions.

To address all previously described deficiencies a new device has been devised: a “hands-free automatic flashlight” which (when mounted over the screwdriver) automatically turns itself ON, holds itself to the screwdriver's shaft. In doing so, it series another important need, as it magnetizes the screwdriver shaft enabling end point to hold the screw being used, and precisely illuminates the target work area without the need of using the other hand or blocking the user's view.

Special focus to this invention has been given to the total energy consumption and therefore the total number of hours it will be able to provide light. Therefore this invention has been designed using a combination of high-efficiency and high-power white light emitting diodes (LED) as light source, miniature high-power batteries to supply the require energy, miniature high-power Neodymium magnet to self-attach to the screwdriver, custom focusing lens to direct the light onto the work area, and proprietary power-ON/OFF switch actuator. All these components have been housed in a rugged, electrically safe non-conductive and easy to use enclosure.

Further, it would be desirable to achieve a device capable of performing previously described functions that is also designed to be a very low cost disposable device. That can be accomplished by the simplification of the housing parts, simplified electronic circuitry, and the usage of standard non-rechargeable batteries.

It would also be desirable a similar device that can be reused over and over. Such implementation could be obtained by adding some features to the device's housing, upgrading its electronic circuitry, and replacing the standard batteries with a rechargeable type.

Finally, this invention features a built-in automatic ON/OFF switch which turns ON and OFF the device by its simple insertion/extraction into/from the screwdriver.

In its disposable form, this device does not requite any maintenance as it is discarded when the batteries are fully depleted (the customary disposal regulations apply).

In its reusable/rechargeable implementation, this device only requires the batteries to be removed if a long period of not use is expected (to avoid damage to the device due to possible leakage of chemicals from batteries) or replacement of the batteries if they are unable to hold a charge.

### BRIEF DESCRIPTION OF THE DRAWINGS

A further understanding of the present invention can be obtained by reference to a preferred embodiment set forth in the illustrations provided in the accompanying drawings. The intention of the drawings is not to limit the scope of this invention, but to help in clarifying the invention. Although the illustrated embodiment is merely exemplary of systems for carrying out the present invention, both the designs and operation techniques of the invention, in general, together with further objectives and advantages thereof, may be more easily understood by reference to the drawings and the following description, as follows:

FIG. 1 represents a complete device of this invention fully assembled, indicating each of the external elements of the system in accordance with the preferred embodiment of the present invention including the main housing, housing cover, optic lens, holding magnet, and automatic insertion switch.

FIG. 2 shows the assembled complete device with the optional external power jack for charging the optional rechargeable batteries.

FIG. 3 illustrates this invention in its intended/typical application.

FIG. 4 details an exploded and complete view of all the electromechanical components comprising this invention.

FIG. 5 depicts the electro mechanics sub-assembly section of the invention, showing the back of the system printed circuit board, the three batteries with their corresponding holders, and the back section of the automatic-insertion power switch.

FIG. 6 displays the electro mechanics sub-assembly section of the invention, showing the front of the system printed circuit board, the three LED light sources, and the front section of the automatic-insertion power switch.

FIG. 7 shows the automatic insertion switch in its deactivated OFF (open) position.

FIG. 8 demonstrates the automatic insertion switch in its activated ON (closed) position.

FIG. 9 discloses the additional multiple features of the optical lenses.

### DETAIL DESCRIPTIONS OF THE INVENTION

All illustrations of the drawings and descriptions of the embodiments are for the purpose of describing selected versions of the present invention and are not intended to limit the scope of the present invention.

The present invention addresses a very real problem humans face too frequently: the inability of see screws they are trying to reach in very dark spaces or tight locations. This invention provides a practical and elegant solution to a hands-free automatic flashlight capable of projecting light precisely to the working target area when coupled to a screwdriver.

Specifically, the present invention allows by design to be used practically anywhere where an area needs illumination so the task can be properly accomplished. The invention consists of a very small and lightweight device, comprised of the following components: 1) main housing, 2) optical lens, 3) a PCBA (printed circuit board assembly), 4) a small/powerful permanent magnet, and 5) a housing back cover. The PCBA includes the following parts: a) a printed circuit board, b) three light sources (LEDs), c) three battery holders, d) three miniature batteries, and e) an electrical switch.

To obtain a small/lightweight device all elements have been design as small as practical and the materials have been carefully selected.

Special attention has been given to the invention's energy efficiency and supply, which determines the duration of available illumination. In the invention's basic form (as a disposable device) the preferable power source has been identified as “oxide-argent” batteries in the SR44W universal size. For the alternate form (as a reusable device) Ni-MH batteries of the same size are used and a charging circuitry complemented with the corresponding external jack. All versions use high-efficiency and high-power white light emitting diodes.

While not in use, energy conservation is obtained by simply removing the device from the screwdriver and the built-in ON/OFF switch automatically disconnects all power.

### DETAILED DESCRIPTION OF THE PREFERRED EMBODIMENT

As required, a detailed illustrative embodiment of the present invention is disclosed herein. However, methods, aesthetics, materials, techniques and designed structures in accordance with the present invention could be embodied in multiple forms and modes, some of which may be significantly different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

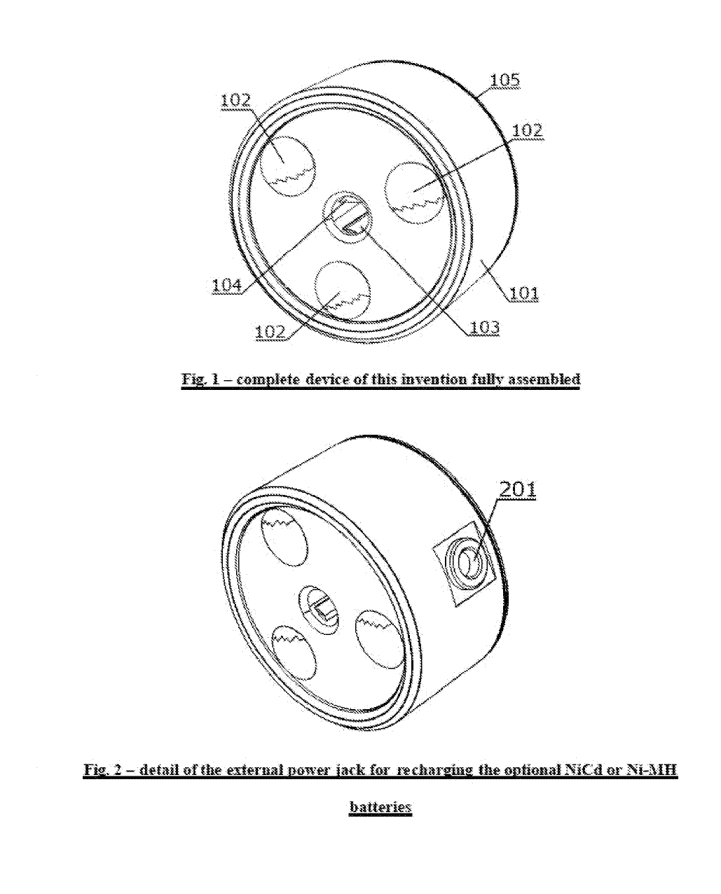

Referring initially to FIG. 1, in accordance with the preferred embodiment of the present invention, depicted is the complete hands-free automatic flashlight device, in an isometric view. This figure shows the main enclosure 101, the three optical lenses 102, the holding magnet 103, and the automatic insertion power switch 104, and the back cover 105.

Although the preferred embodiment of the invention depicted in FIG. 1, discloses a cylindrical housing 101, the invention is not limited to that geometry, therefore the device housing may also be implemented with substantially different shape(s).

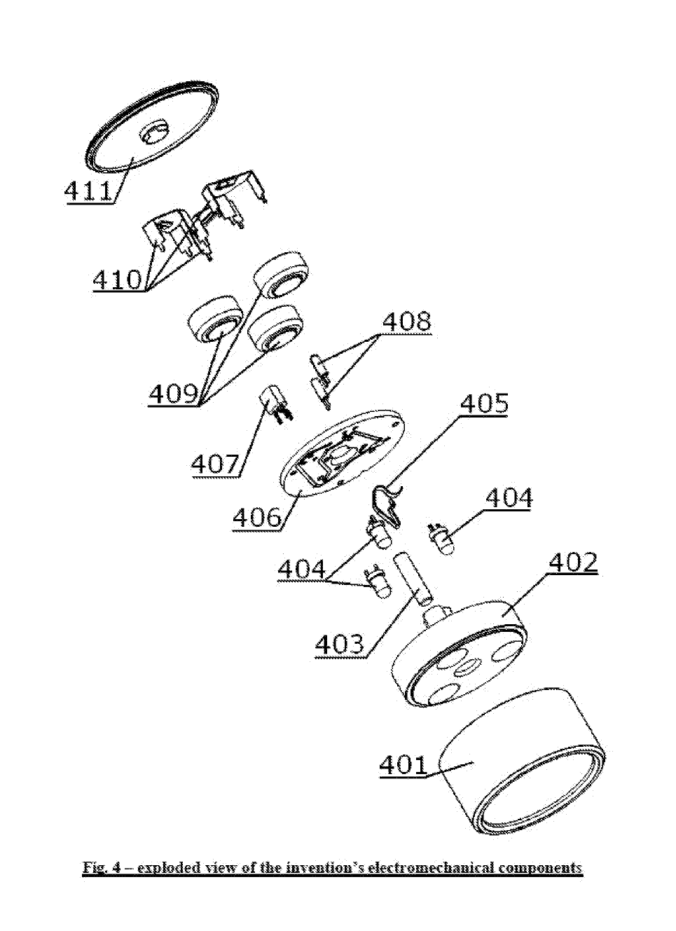

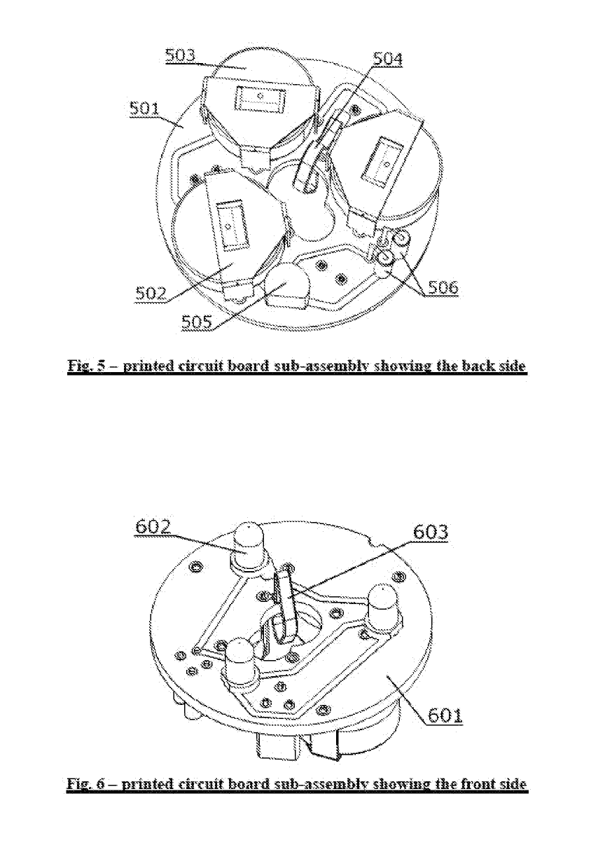

The system housing 101 serves multiple functions: encloses the printed circuit board subassembly (see FIGS. 5 and 6) with its electronic component; provides support to hold the optical leases 102, and along with the back cover 105 (411 on FIG. 4) provides the necessary environmental and shock protections.

In the preferred embodiment the back cover 105 is permanently attached to the main housing 101.

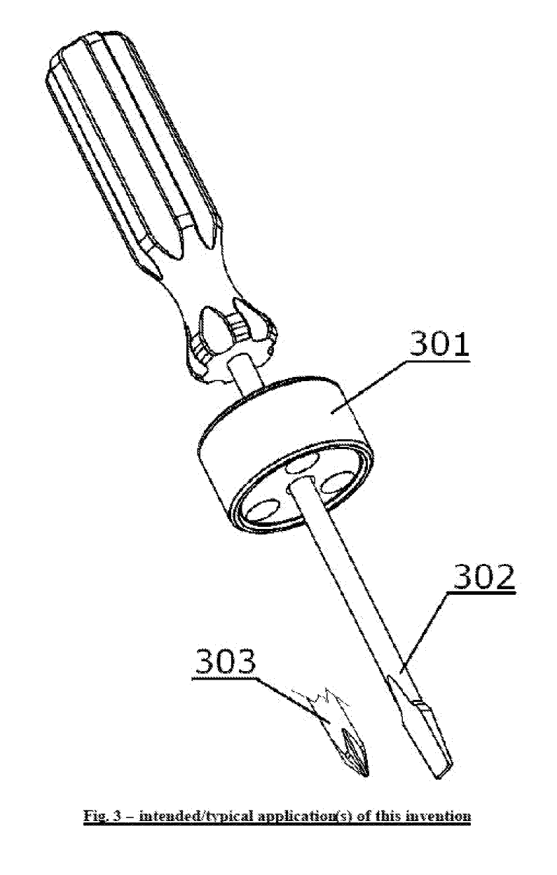

Also FIG. 3 shows this device 301 in a typical application with a standard 3/16″ diameter flat screwdriver 302, or alternatively a 3/16″ diameter Phillips screwdriver 303.

In addition to the example given in FIG. 3, in its preferred embodiment, the invention will also work with screwdrivers of other smaller diameter sizes and tips (Square, Hex, Pentagon, Slot, Cross, Phillips, Frearson, Mortorq, Pozidriv, Supadriv, Robertson, Hexalobular, TTAP, Phillips/square, Bristol, One-way, Pentalobe, Polydrive, Spanner, Spline, Torq-set, TA, TP3, Tri-wing, etc.) as long as the screwdriver's shaft measures between 0.1″ and 0.19″ in diameter.

An exploded view of the preferred invention is presented in FIG. 4, which discloses the complete assembly in detail, as follows: main housing 401, optical lenses 402, holding magnet 403, LED light sources 404, automatic insertion switch 405, printed circuit board 406, transistor 407, resistors 408, batteries 409, battery holders 410, and back cover 411.

FIG. 5 demonstrates the back side of the assembled printed circuit board, showing the printed circuit board 501, battery holders 502, batteries 503, automatic insertion switch 504, transistor 505, and resistors 506.

And FIG. 6 is used to show the front side of the assembled printed circuit board, where the printed circuit board 601, LED light sources 602, and automatic insertion switch 603 can be observed.

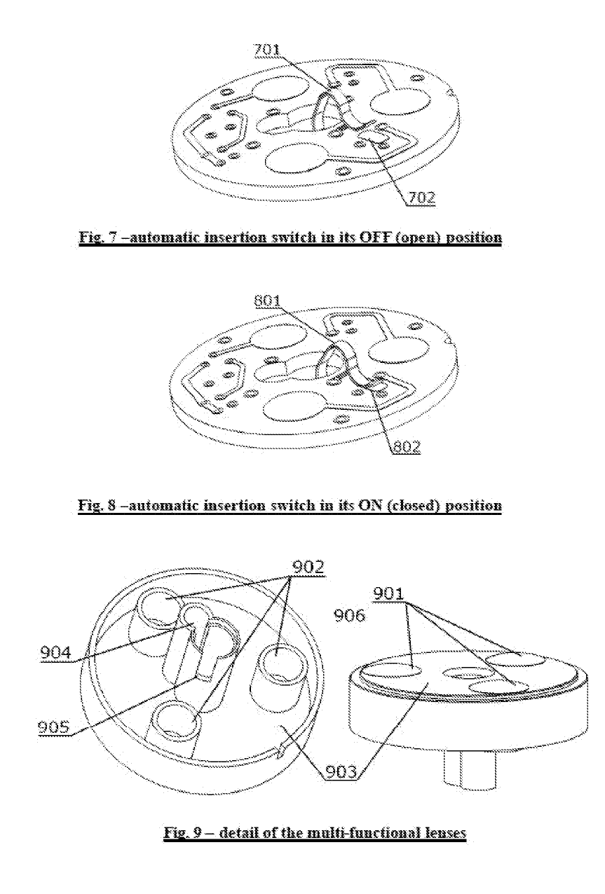

A demonstration of the operation of the automatic insertion switch is illustrated in FIGS. 7 and 8, in OFF (open circuit) and ON (closed circuit) respectively. The circuit is turned ON when the flexible contact leaf is bent by the insertion of the screwdriver into the device forcing the switch's flexible leaf 801 to establish contact with the printed circuit pad 802. Conversely, when the screwdriver is removed from the device the flexible contact leaf 701 returns to its normal shape breaking the contact with the mentioned printed circuit pad 702. Both, switch's flexible leaf and printed circuit pad form the actual automatic insertion power ON/OFF switch.

A close examination of FIG. 9 reveals that the optical lenses are formed as part of a single molded acrylic part that serves six functions: 1) integration of the three independent optical lenses 901; 2) alignment of the LED light sources with the lenses 902; 3) seals the rest of the internal components from the environment with its frontal surface 903; 4) holds the magnet in place 904; 5) allows the automatic insertion switch to detect the screwdriver through a window slot 905; and 6) provides the aperture for the screwdriver to pass thru 906.

### DETAILED DESCRIPTION OF AN ALTERNATE EMBODIMENT

A general understanding of the herein disclose invention clearly opens many other possible applications of the described preferred embodiment.

Although the preferred embodiment had considered and applied the miniaturization as an important criterion, this invention can be scaled up or down to meet other uses, making it possible to be used with many smaller and larger screwdrivers and other hand tools, and its service duration (battery life) could also be modified (extended or shortened) by using batteries of different size and/or technologies.

Equally obvious would be that the overall shape could be changed to other geometries and total length of the device.

One obvious alternate embodiment will be to enhance the preferred embodiment, by extending the actual life of the device. One way in which that could be accomplished without enlarging the device, would be by replacing the disposable “oxide-argent” batteries with a rechargeable type, such as NiCd (nickel-cadmium) or Ni-MH (nickel-metal hydride). To incorporate this enhancement it will be also necessary to modify the main housing and back cover equipping them with the necessary threads, add to the printed circuit board the charging circuitry and an external power input jack 201 to receive the electrical charge, as seen in FIG. 2.

Finally, it is known and understood that many different materials, other than those disclosed herein, can be used successfully in the production of this device.

What is claimed is:

1. An apparatus for illuminating a work area that is supported by the same tool needed for the task, without the necessity of using another hand and without blocking the view path

2. An apparatus according to claim 1, said apparatus further comprising a number of light emitting diodes as light sources.

3. An apparatus according to claim 1, said apparatus further composing a number of oxide-argent batteries to power the light sources of claim 2.

4. An apparatus according to claim 1, said apparatus further comprising an optical lens that focuses the light over the work area.

5. An apparatus according to claim 1, said apparatus further comprising an enclosure that is made of an electrically safe non-conducting material.

6. An apparatus according to claim 1, said apparatus has a thru-hole that permits to attach itself to the shaft of tools of different diameters.

7. An apparatus according to claim 1, said apparatus is a lightweight.

8. An apparatus according to claim 1, said apparatus powers its electrical sub-systems from disposable or rechargeable batteries.

9. An apparatus according to claim 1, said apparatus further comprising an optical lens that has the additional function of sealing internal components from environmental elements such as dust, liquids, etc.

10. An apparatus according to claim 1, said apparatus further comprising an optical lens that has the additional function of supporting its featured holding magnet.

11. An apparatus according to claim 1, said apparatus further comprising an optical lens that has the additional function of providing s window-slot for the auto-insertion switch to operate.

12. An apparatus according to claim 1, said apparatus regular use does not require user maintenance for its power component.
